(19) United States
(12) Patent Application Publication
(10) Pub. No.: US 2026/0031860 A1
(43) Pub. Date: Jan. 29, 2026

(54) POWER CONTROL SCHEME FOR ACTIVE RIS BASED ON NETWORK REQUIREMENTS AND RRC CONNECTION STATES

(71) Applicant: LENOVO (BEIJING) LIMITED, Beijing (CN)

(72) Inventors: Tingnan Bao, Beijing (CN); Jianfeng Wang, Beijing (CN); Haiming Wang, Beijing (CN); Lihua Yang, Beijing (CN)

(21) Appl. No.: 18/994,568

(22) PCT Filed: Jul. 15, 2022
(86) PCT No.: PCT/CN2022/105941

§ 371 Date: Jan. 14, 2025

(51) Int. Cl. H04B 7/04; H04L 43/0805; H04W 74/0833

(52) U.S. Cl. CPC H04B 7/04013; H04L 43/0805; H04W 74/0833

(57) ABSTRACT

Methods and apparatuses for power control schemes for active RIS are disclosed. In one embodiment, a base unit comprises a processor; and a transceiver coupled to the processor, wherein, the processor is configured to transmit, via the transceiver. a message to enable an active RIS.

### FIELD

The subject matter disclosed herein generally relates to wireless communications, and more particularly relates to methods and apparatuses for power control schemes for the active RIS. The power control schemes may be different for different network requirements and different UE connection states.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Reconfigurable Intelligent Surface (RIS), Large Intelligent Surface (LIS), Intelligent Reflecting Surface (IRS), radio frequency (RF), beyond fifth generation (B5G), sixth generation (6G), transmission-reception point (TRP), full-duplex amplify-and-forward (FD-AF), Physical Random Access Channel (PRACH), Physical Uplink Control Channel (PUCCH), Physical Uplink Shared Channel (PUSCH), Quality of Service (QOS), radio access network (RAN), electromagnetic (EM), Radio Link Monitoring (RLM), layer 1 signal to interference plus noise ratio (L1-SINR), layer 1 reference signal receive power (L1-RSRP), reference signal receive quality (RSRQ), channel quality indicator (CQI), power headroom report (PHR).

Reconfigurable Intelligent Surface (RIS) can be alternatively referred to as Large Intelligent Surface (LIS), Intelligent Reflecting Surface (IRS) or Intelligent Metasurface. RIS is a large and thin metasurface of metallic or dielectric material, comprised of an array of passive sub-wavelength scattering elements with specially designed physical structure. The scattering elements can be controlled in a software-defined manner to change the electromagnetic (EM) properties (e.g., phase shift) of the reflection of the incident radio frequency (RF) signals. By a joint phase control of all scattering elements, the reflected radiation pattern of the incident RF signals can be arbitrarily tuned in real time, thus creating new degrees of freedom to the optimization of the overall wireless network performance. RIS can real-time control the response of electromagnetic wave effectively and is considered as one of the potential key technologies for beyond fifth generation (B5G) system and even sixth generation (6G) system.

A typical deployment of RIS is illustrated in FIG. 1, where the RIS (e.g., located on the wall or the ceiling of a smart factory) is controlled by a base station (BS), e.g., gNB or TRP, via a dedicated interface (note that the interface may be defined if the RIS is regarded as a new node category in 6G networks). The RIS forwards the signal from the BS to the target user equipment (UE), where it is assumed that there is no direct link between the gNB and the UE. That is, the RIS forms a cascaded channel between the BS and the UE (i.c., a channel between gNB and RIS, and a channel between RIS to UE).

The RIS shown in FIG. 1 can be referred to as a passive RIS since the scattering elements are passive elements. The passiveness of a RIS element implies that there is no added noise within the circuit. As such, the passive RIS may be introduced in B5G and/or 6G network to improve the capacity gains. However, in practice, if wireless transmission happens when the direct link is not too weak, the capacity gain introduced by the passive RIS can be negligible. Experimental results show that the passive RIS requires thousands of elements to obtain the same level of capacity gain than that from the direct link. These thousands of elements at RIS can lead to higher complexity and increase signal overhead.

To overcome the disadvantage of fundamental limitation of the passive RIS, active RIS was proposed. FIG. 2 illustrates the active RIS, where each RIS reflecting element has power supply for the reflected signals. It means that a reflection-type amplifier is imposed into each reflecting element to actively reflect signals with amplification. Although the active RIS will introduce the thermal noise and additional power consumption for the amplifier in each active element, the number of elements in the active RIS can be extremely less than that of the passive RIS to achieve the same level of system capacity gains in the scenario where there is strong direct link between the gNB and the UE.

The active RIS is not the same as the relay-type (i.c., passive) RIS equipped with RF chains, which makes the system more complexed with a set of signal process modules. The active RIS is not the same as the full-duplex amplify-and-forward (FD-AF) relay, neither, since FD-AF relay needs two time slots to complete the transmission of one symbol. Although the active RIS has its own benefits to enhance the wireless transmission between gNB and UE, the active RIS needs additional power supply for each element.

In 3GPP 4G LTE, the power control is introduced to maximize the power of the desired received signals while limiting the generated interference. The LTE power control mechanism includes a closed loop component operating around an open loop point of operation. For example, the open loop control, which is a mechanism of PRACH transmission power, enables a trade-off between cell edge bitrate and cell capacity. The closed loop control, which is a mechanism of PUCCH or PUSCH channel power with UE in connected state (e.g., RRC_CONNECTED state), can enable fast channel quality variations. NR enhanced power control can provide the possibility for beam-based power control.

Because of the new introduced power supply unit for each element in the active RIS, it is necessary to control the power setting of the active RIS deployed in radio access network (RAN) according to the complicated propagation environment, link quality, traffic QoS requirements, RRC connection states, UEs' mobility and so on. For the 6G standardization, it is necessary to consider the power control schemes for the active RIS, which is supposed to be a key component equipment in 6G.

This invention targets power control schemes for the active RIS.

### BRIEF SUMMARY

Methods and apparatuses for power control schemes for active RIS are disclosed.

In one embodiment, a base unit comprises a processor; and a transceiver coupled to the processor, wherein, the processor is configured to transmit, via the transceiver, a message to enable an active RIS.

In some embodiment, the message is transmitted to enable the active RIS in response to one of: determining that link performance is worse than a threshold; receiving, via the transceiver, a request to enable the active RIS; not receiving a response to the paging within a pre-defined time window; and in a configured random access occasion. In particular, the processor is further configured to receive, via the transceiver, the link performance.

In some embodiment, the processor is further configured to transmit, via the transceiver, a message to set a power value to the active RIS. In particular, the power value is set according to QoS requirement and/or link performance.

In some embodiment, the processor is further configured to transmit, via the transceiver, a message to set reflecting coefficients to the active RIS. In particular, the reflecting coefficients are determined according to the link performance, or determined to maximize coverage.

In another embodiment, a method performed at a base unit comprises transmitting a message to enable an active RIS.

In still another embodiment, a UE comprises a processor; and a transceiver coupled to the processor, wherein, the processor is configured to transmit, via the transceiver, a request to enable an active RIS.

In some embodiment, the processor is further configured to transmit, via the transceiver, link performance.

In yet another embodiment, a method performed at a UE comprises transmitting a request to enable an active RIS.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a typical deployment of RIS in a modern mobile communication system;

FIG. 2 illustrates an active RIS;

FIG. 3 illustrates a general interaction among gNB, active RIS and UE;

FIG. 4 illustrates power control scheme of the active RIS according to a first embodiment;

FIG. 5 illustrates another power control scheme of the active RIS according to the first embodiment;

FIG. 6 illustrates power control scheme of the active RIS according to a second embodiment;

FIG. 7 illustrates another power control scheme of the active RIS according to the second embodiment;

FIG. 8 is a schematic flow chart diagram illustrating an embodiment of a method;

FIG. 9 is a schematic flow chart diagram illustrating another embodiment of a method; and

FIG. 10 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), crasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”. “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

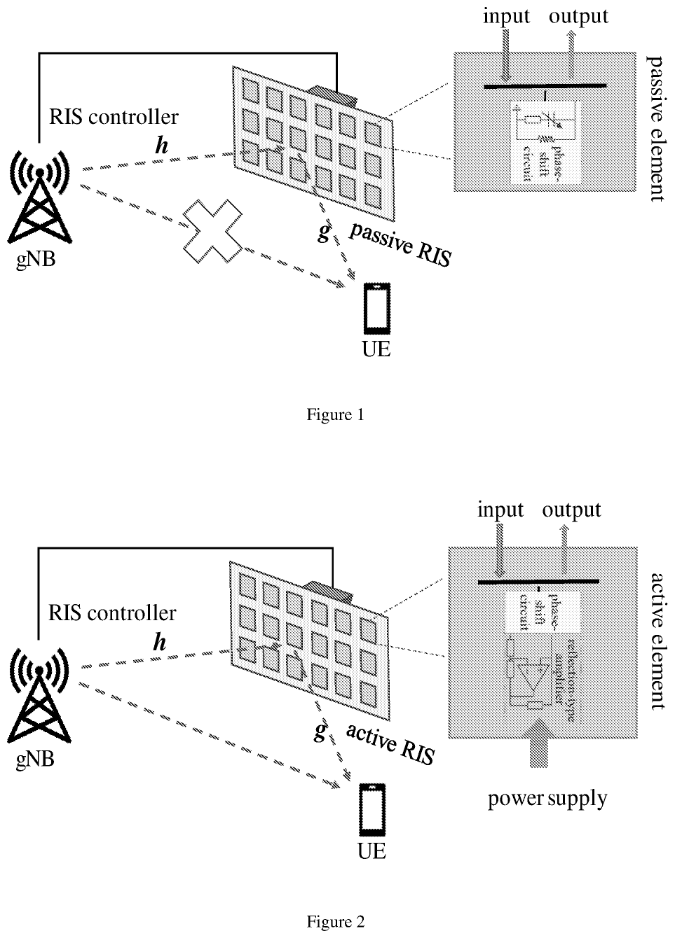

This disclosure proposes power control schemes for the active RIS in RAN. It is assumed that an active RIS as shown in FIG. 2 is deployed in RAN to enhance the link between gNB and UE served by the gNB. As shown in FIG. 2, the active RIS is comprised of an array of reflecting elements each of which changes the electromagnetic (EM) properties (e.g., phase shift) of the reflection of the incident radio frequency (RF) signals. That is, the EM properties of the reflection of each reflecting element can be adjusted by a reflecting coefficient. The reflecting coefficients of all reflecting elements can be jointly controlled. It means that the gNB can adjust the reflecting coefficients of all reflecting elements of the active RIS in a joint manner. Each reflecting clement is provided with a power supply, and accordingly can be referred to as active reflecting element. With power provided to the active reflecting element, the active reflecting element can amplify the reflected RF signals. The amplification is higher when the power is higher.

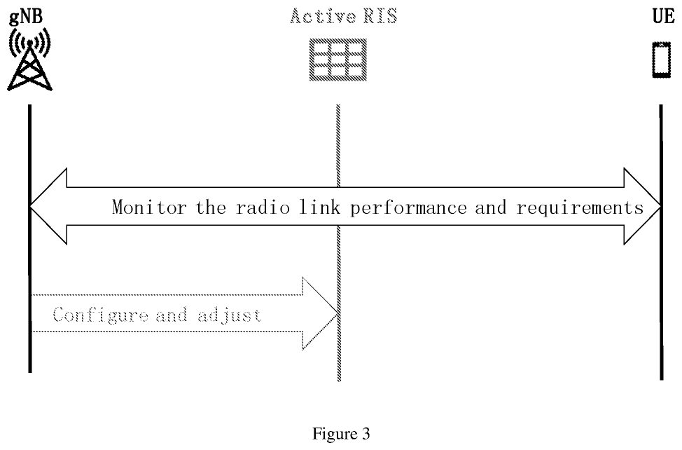

A general interaction among gNB, active RIS and UE is illustrated in FIG. 3.

It can be seen that information interaction can be between gNB and UE, and from gNB to active RIS. The information interaction between gNB and UE is to monitor the radio link performance and requirements between gNB and UE. The information interaction from gNB to active RIS is one-way communication to configure and adjust the active RIS.

The following assumptions are assumed:
(1) An air interface exists between gNB and active RIS. The air interface may be a known interface (e.g., Uu interface) if the active RIS is regarded as a special UE. Alternatively, the air interface may be a newly defined interface if the active RIS is regarded as a new kind of network node.
(2) The active RIS is fully controlled by the gNB via the air interface.
(3) The gNB can control the active RIS by sending messages to the active RIS. The messages may include: message to enable or disable the active RIS, message to set a power value to the active RIS, message to configure coefficients of the reflecting elements of the active RIS.
(4) The active RIS is deployed and controlled by gNB to improve the link performance of the UEs served by the gNB in a target area.
(5) The active RIS can be enabled or disabled by the message to enable or disable the active RIS. In default, the active RIS is disabled (or in a disabled status). It means that the power of the active RIS is disabled. Neither the power of reflecting elements nor the reflecting coefficients of the reflecting elements can be controlled if the active RIS is disabled (or in the disabled status). In other words, in the disabled status, the active RIS does not change EM properties (e.g., phase shift) of the reflection of the incident RF signals, nor amplify the reflected RF signals.
(6) When the active RIS is enabled, it can be in a passive mode, in which the power of each element of the active RIS is set as OdB. It means that each element is not supplied with power. In other words, the active RIS in the passive mode can be considered as a passive RIS. The reflecting coefficients of all reflecting elements of the active RIS in the passive mode can be jointly controlled (or adjusted). A bit of power may be consumed for coefficients adjustment.
(7) When the active RIS is enabled, it can also be in an active mode, in which both the power of reflecting elements and the reflecting coefficients of the reflecting elements can be controlled. In this disclosure, it is assumed that only one power value is set to the active RIS. It means that the set power value applies to all of the reflecting elements of the active RIS. On the other hand, the reflecting coefficients of the reflecting elements can be separately set. It means that the reflecting coefficients of all reflecting elements can be set jointly while each reflecting coefficient can be different from other reflecting coefficient(s).

The UE can be in different states. For example, the UE can be in connected state (e.g., RRC_CONNECTED state) or non-connected state (e.g., RRC_IDLE state or RRC_INACTIVE state). The UE in connected state has established a connection with the network (e.g., gNB). On the other hand, the UE in non-connected state needs to monitor the paging message from the network.

In different states, the messages collected from UE to adjust the active RIS would be different. So, the power control schemes for the active RIS would be different for UE in different states.

A first embodiment relates to power control schemes of the active RIS for the UE in connected state (e.g., RRC_CONNECTED state).

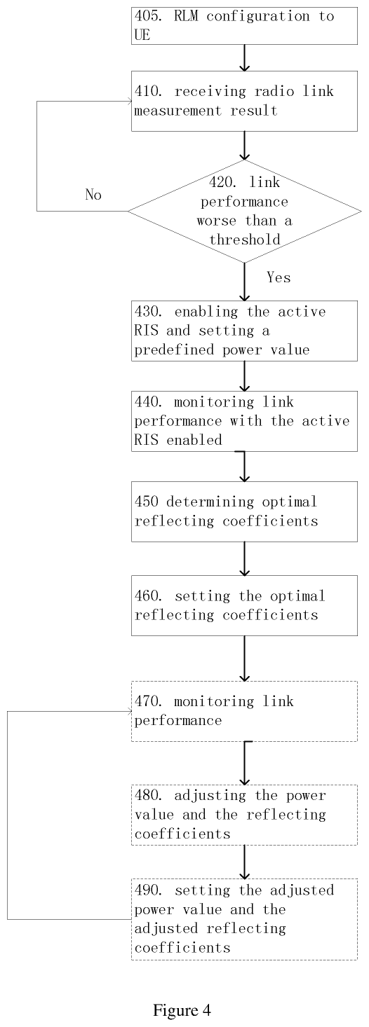

FIG. 4 illustrates the power control scheme of the active RIS for the UE in connected state (e.g., RRC_CONNECTED state), which is triggered by the gNB.

In default, the active RIS is disabled if the radio link is good enough for the requirement.

The gNB always monitors the radio link performance between the gNB and the UE. In step 405, the gNB sends a Radio Link Monitoring (RLM) configuration to the UE. The configuration may include the signal(s) to be measured and the metric(s) to be reported. The UE monitors the radio link performance according to the RLM configuration. For example, the UE may monitor layer 1 signal to interference plus noise ratio (L1-SINR) or layer 1 reference signal receive power (L1-RSRP). The UE may report at least one of the following metrics: RSRP, reference signal receive quality (RSRQ), channel quality indicator (CQI), and power headroom report (PHR), etc.

In step 410, the gNB receives the radio link measurement result from the UE. The radio link measurement result includes the link performance, which is value(s) of the metric(s) reported by the UE. Note that the link performance in step 410 is of the direct link between the gNB and the UE, since the active RIS is disabled (or in a disabled status).

In step 420, the gNB determines whether the link performance is worse than a threshold, e.g., according to QoS requirements (e.g., throughput, or block error rate). If the link performance is better than the threshold, the gNB determines that the radio link is good and keeps the active RIS in the disabled status.

If the link performance is worse than the threshold (or alternatively, the gNB predicts that the link performance will be worse than the threshold), the gNB determines to enable the active RIS and set a predefined power value in step 430. The threshold can be determined according to the QoS requirements (e.g., throughput, block error rate, etc.). In addition, the predefined power value may be determined according to link performance and/or the QoS requirements. For example, the predefined power value can be a power value that can compensate the degraded performance to facilitate the channel estimation for determining the optimal reflecting coefficients. The predefined power value applies to all reflecting elements of the active RIS. If the link performance is better than the threshold (step 420, ‘NO’), the gNB continues to receive the radio link measurement result from the UE.

In step 440, gNB continuously monitors the link performance by receiving the link performance reported from the UE. Since the active RIS is enabled, the link performance indicates the both the direct link between the gNB and the UE and the cascaded link between the gNB and the active RIS and between the active RIS and the UE.

According to the link performance received in step 440, the gNB determines the optimal reflecting coefficients of all reflecting elements of the active RIS in step 450. In particular, each reflecting element has its own optimal reflecting coefficient.

In step 460, the gNB sets the optimal reflecting coefficients jointly to the active RIS. In particular, each reflecting element of the active RIS is set with its own optimal reflecting coefficient.

Steps 470 to 490 are optional steps.

In step 470, the gNB continues to monitor (e.g., occasionally monitors) the link performance by receiving the link performance reported from the UE.

In step 480, the gNB adjusts the power value and the reflecting coefficients according to the link performance received in step 470. For example, If the L1-SINR is larger than a first threshold, the power value of the active RIS can be reduced for power saving. On the other hand, if the L1-SINR is lower than a second threshold, the power of the active RIS can be increased to satisfy the requirements.

In step 490, the gNB sets the adjusted power value and the adjusted reflecting coefficients to the active RIS.

Steps 470 to 490 can be repeatedly performed.

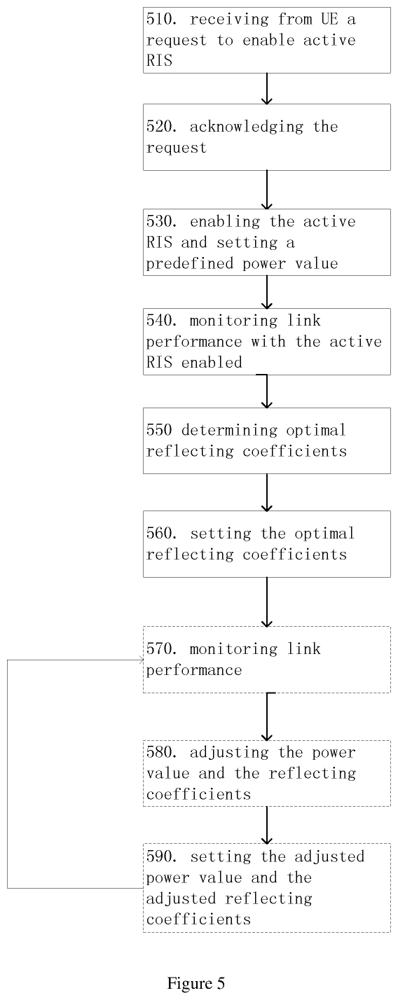

FIG. 5 illustrates another power control scheme of the active RIS for the UE in connected state (e.g., RRC_CONNECTED state), which is triggered by the UE.

It is assumed that the deployment of the active RIS is available to the UE.

In step 510, the gNB receives from UE a request to enable the active RIS. For example, the UE knows that the active RIS is available and is in a disabled status. The UE considers that if the active RIS is enabled, uplink transmit power of the UE can be saved, and accordingly, the UE sends the gNB a request to enable the active RIS.

In step 520, the gNB acknowledges the request by the UE.

In step 530, the gNB determines to enable the active RIS and set a predefined power value. The predefined power value may be determined to facilitate the channel estimation for determining the optimal reflecting coefficients.

The following steps 540 to 590 are the same as steps 440 to 490. So, the detailed explanation of steps 540 to 590 is omitted.

According to the first embodiment, the active RIS is enabled and controlled to improve the link performance of the UE in connected state (e.g., RRC_CONNECTED state).

A second embodiment relates to power control schemes of the active RIS for the UE in non-connected state (e.g., RRC_IDLE state or RRC_INACTIVE state).

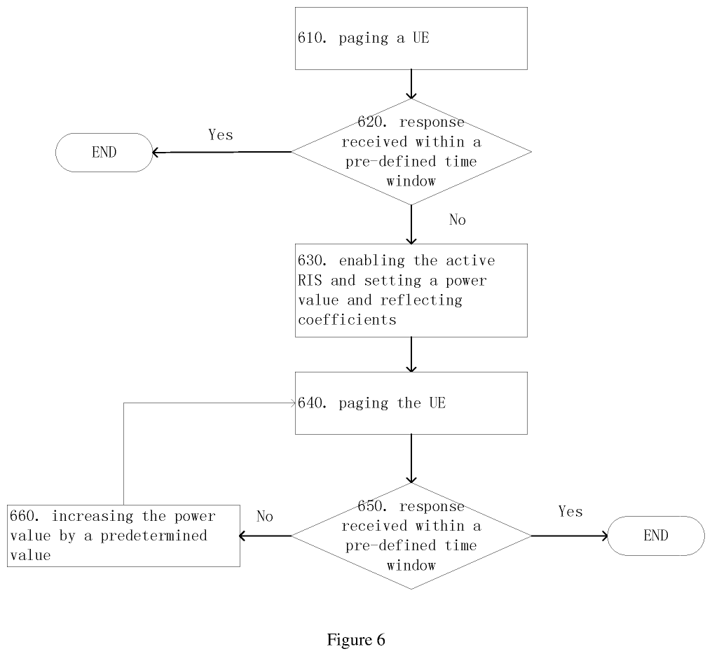

FIG. 6 illustrates power control scheme for paging UEs in non-connected state (e.g., RRC_IDLE state or RRC_INACTIVE state).

In default, the active RIS is disabled.

In step 610, the gNB pages a UE in the condition that the active RIS is disabled (i.e., with the active RIS in disabled status), and waits for response from the UE (i.e., waiting for random access from the UE).

In step 620, the gNB determines whether the response to the paging is received within a pre-defined time window.

If the response is not received within the pre-defined time window, in step 630, the gNB enables the active RIS and sets a power value and reflecting coefficients for the reflecting elements of the active RIS.

The reflecting coefficients are determined to maximize coverage, e.g., the reflecting coefficients for a broad reflection beam or beam sweeping. The optimal reflecting coefficients cannot be determined since the position of the UE is unavailable to the gNB.

The power value is determined according to predetermined coverage. The set power value is applied to all reflecting elements of the active RIS.

In step 640, the gNB pages the UE with the enabled active RIS with the set reflecting coefficients and the set power value.

In step 650, the gNB determines whether the response to the paging is received within a pre-defined time window.

If the determination is ‘No’ in step 650, the gNB increases the power value by a predetermined value to enlarge the coverage in step 660.

Then, the procedure continues back to step 640 to page the UE with the enabled active RIS with the set reflecting coefficients and the increased power value.

If the determination is still ‘No’ in step 650, steps 660, 640 and 650 repeat, until the determination is ‘Yes’ in step 650, i.e., the response to the paging is received (e.g., random access from the UE is received at gNB).

Incidentally, if the power value is increased to the maximum power value while the gNB still cannot receive the response from the UE, the procedure ends with failure to page the UE.

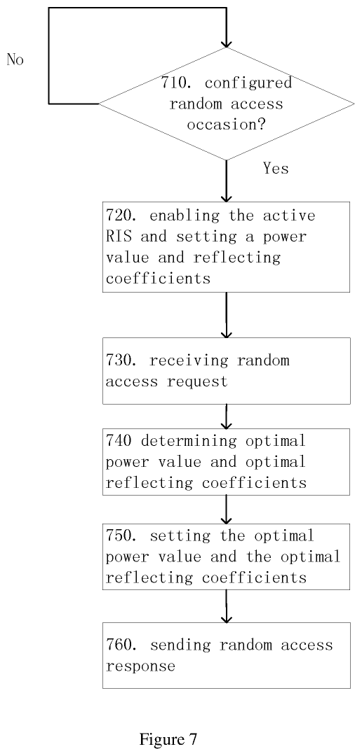

FIG. 7 illustrates power control scheme for UE random access in non-connected state (e.g., RRC_IDLE state or RRC_INACTIVE state)

In default, the active RIS is disabled.

In step 710, the gNB confirms that it is an occasion for a configured random access.

In step 720, the gNB enables the active RIS and set a power value and reflecting coefficients for the reflecting elements of the active RIS.

The reflecting coefficients are determined to maximize, e.g., the reflecting coefficients for a broad reflection beam or beam sweeping. The optimal reflecting coefficients cannot be determined since the position of the UE is unavailable to the gNB.

The power value is determined according to predetermined coverage. The set power value is applied to all reflecting elements of the active RIS.

In step 730, the gNB receives the random access request (e.g., Msg1) from the UE, with the active RIS being enabled and the power value and the reflecting elements set in step 720.

In step 740, the gNB determines optimal power value and optimal reflecting coefficients of the active RIS according to the received random access request.

In step 750, the gNB sets the optimal power value and the optimal reflecting coefficients to the active RIS.

In step 760, the gNB sends the random access response (e.g., Msg2) to the UE with the optimal power value and the optimal reflecting coefficients set in step 750.

Optionally, the power value can be further adjusted in the random access procedure. For example, if the gNB receives Msg3 from the UE, the power value can be adjusted according to the received Msg3. Accordingly, the adjusted power value can be set to the active RIS before the gNB sends a response (e.g., Msg4) to the Msg3.

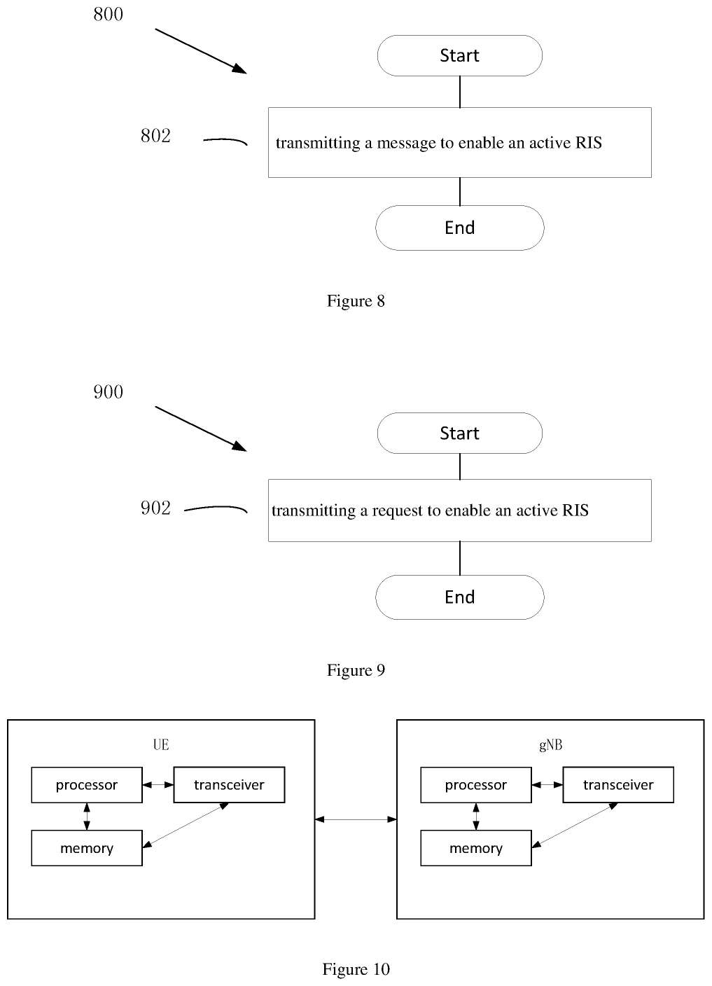

FIG. 8 is a schematic flow chart diagram illustrating an embodiment of a method 800 according to the present application. In some embodiments, the method 800 is performed by an apparatus, such as a base station. In certain embodiments, the method 800 may be performed by a processor executing program code, for example, a microcontroller, a microprocessor, a CPU, a GPU, an auxiliary processing unit, a FPGA, or the like.

The method 800 may include 802 transmitting a message to enable an active RIS.

In some embodiment, the message is transmitted to enable the active RIS in response to one of: determining that link performance is worse than a threshold; receiving, via the transceiver, a request to enable the active RIS; not receiving a response to the paging within a pre-defined time window; and in a configured random access occasion. In particular, the method may further comprise receiving the link performance.

In some embodiment, the method further comprises transmitting a message to set a power value to the active RIS. In particular, the power value is set according to QoS requirement and/or link performance.

In some embodiment, the method further comprises transmitting a message to set reflecting coefficients to the active RIS. In particular, the reflecting coefficients are determined according to the link performance, or determined to maximize coverage.

FIG. 9 is a schematic flow chart diagram illustrating an embodiment of a method 900 according to the present application. In some embodiments, the method 900 is performed by an apparatus, such as a remote unit (e.g., UE). In certain embodiments, the method 900 may be performed by a processor executing program code, for example, a microcontroller, a microprocessor, a CPU, a GPU, an auxiliary processing unit, a FPGA, or the like.

The method 900 is a method performed at a UE, comprising: 902 transmitting a request to enable an active RIS.

In some embodiment, the method further comprises transmitting link performance.

FIG. 10 is a schematic block diagram illustrating apparatuses according to one embodiment.

Referring to FIG. 10, the gNB (i.e., the base unit) includes a processor, a memory, and a transceiver. The processor implements a function, a process, and/or a method which are proposed in FIG. 8.

The base unit comprises a processor; and a transceiver coupled to the processor, wherein, the processor is configured to transmit, via the transceiver, a message to enable an active RIS.

In some embodiment, the message is transmitted to enable the active RIS in response to one of: determining that link performance is worse than a threshold; receiving, via the transceiver, a request to enable the active RIS; not receiving a response to the paging within a pre-defined time window; and in a configured random access occasion. In particular, the processor is further configured to receive, via the transceiver, the link performance.

In some embodiment, the processor is further configured to transmit, via the transceiver, a message to set a power value to the active RIS. In particular, the power value is set according to QoS requirement and/or link performance.

In some embodiment, the processor is further configured to transmit, via the transceiver, a message to set reflecting coefficients to the active RIS. In particular, the reflecting coefficients are determined according to the link performance, or determined to maximize coverage.

Referring to FIG. 10, the UE (i.e., the remote unit) includes a processor, a memory, and a transceiver. The processor implements a function, a process, and/or a method which are proposed in FIG. 9.

The UE comprises a processor; and a transceiver coupled to the processor, wherein, the processor is configured to transmit, via the transceiver, a request to enable an active RIS.

In some embodiment, the processor is further configured to transmit, via the transceiver, link performance.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A base station, comprising:
at least one memory; and
at least one processor coupled with the at least one memory and configured to cause the base station to:
transmit a message to enable an active reconfigurable intelligent surface (RIS).

2. The base station of claim 1, wherein the at least one processor is configured to cause the base station to transmit the message to enable the active RIS in response to one of:
determining that link performance is worse than a threshold;
receiving a request to enable the active RIS;
not receiving a response to a paging within a pre-defined time window; and
in a configured random access occasion.

3. The base station of claim 2, wherein the at least one processor is configured to cause the base station to:
receive the link performance.

4. The base station unit of claim 1, wherein the at least one processor is configured to cause the base station to:
transmit a message to set a power value to the active RIS.

5. The base station of claim 4, wherein the power value is set according to quality of service (QOS) requirement and/or link performance.

6. The base station unit of claim 1, wherein the at least one processor is configured to cause the base station to:
transmit a message to set reflecting coefficients to the active RIS.

7. The base station unit of claim 6 wherein the reflecting coefficients are determined according to a link performance, or determined to maximize coverage.

8. A method performed a base station, the method comprising:
transmitting a request to enable an active reconfigurable intelligent surface (RIS).

9. The method of claim 8, wherein a message is transmitted to enable the active RIS in response to one of:
determining that link performance is worse than a threshold;
receiving a request to enable the active RIS;
not receiving a response to a paging within a pre-defined time window; and
in a configured random access occasion.

10. The method of claim 9, further comprising: receiving the link performance.

11. The method of claim 8, further comprising: transmitting a message to set a power value to the active RIS.

12. The method of claim 11, wherein the power value is set according to quality of service (QOS) requirement and/or link performance.

13. The method of claim 8, further comprising: transmitting a message to set reflecting coefficients to the active RIS.

14. A user equipment (UE), comprising
at least one memory; and
at least one processor coupled with the at least one memory and configured to cause the UE to:
transmit a request to enable an active reconfigurable intelligent surface (RIS).

15. The UE of claim 14, wherein the at least one processor is configured to cause the UE to:
transmit link performance.

16. A processor for wireless communication, comprising:
at least one controller coupled with at least one memory and configured to cause the processor to:
transmit a message to enable an active reconfigurable intelligent surface (RIS).

17. The processor of claim 16, wherein the at least one controller is configured to cause the processor to transmit the message to enable the active RIS in response to one of:
determining that link performance is worse than a threshold;
receiving a request to enable the active RIS;
not receiving a response to a paging within a pre-defined time window; and
in a configured random access occasion.

18. The processor of claim 17, wherein the at least one controller is configured to cause the processor to:
receive the link performance.

19. The processor of claim 16, wherein the at least one controller is configured to cause the processor to:
transmit a message to set a power value to the active RIS.

20. The processor of claim 19, wherein the power value is set according to quality of service (QOS) requirement and/or link performance.
